(19) United States
(12) Patent Application Publication
(10) Pub. No.: US 2018/0352781 A1
(43) Pub. Date: Dec. 13, 2018

(54) Indoor Canine Litter Box With An All Natural Pine Pellet Litter

(71) Applicant: Tami A. McCann, Barberton, OH (US)

(72) Inventors: Duane P. McCann, Barberton, OH (US); Tami A. McCann, Barberton, OH (US)

(21) Appl. No.: 16/050,023

(22) Filed: Jul. 31, 2018

Related U.S. Application Data
(60) Provisional application No. 62/684,172, filed on Jun. 12, 2018.

(51) Int. Cl. A01K 1/015

(52) U.S. Cl. CPC A01K 1/0155

(57) ABSTRACT

A method targeted for waste removal using an all-natural pine pellet to be used in an indoor canine (dog) litter box. An all-natural pine pellet made from natural pine sawdust/pine sawdust particles, compressed and formed to make a pellet for the specific use in a canine litter box. This all-natural pine pellet litter is naturally highly absorbent; dust free; odor controlling and biodegradable. Canine (dog) specific, urinates on said all-natural pine pellet, the pine pellet swells over time, pine pellet breaks down back into its original form of all-natural pine sawdust/pine sawdust particles, and when canine (dog) defecates on said all-natural pine pellet, the pine pellet remains solid for easy removal of solid waste.

### THE FIELD OF INVENTION

A method for removal of dog waste by the use of all-natural pine sawdust/pine sawdust particles, formed into shaped pellets to be used in an indoor canine litter box. The formed pine pellets are all-natural, free of chemicals, perfumes, additives and dust free. Highly absorbent, natural odor controlling and biodegradable.

### BACKGROUND OF THE INVENTION

There are approximately 7.6 million companion animals that enter animal shelters nationwide every year and of those, approximately 3.9 million are dogs. Many people want to be pet owners, but not everyone's situation can accommodate a dog. Busy work and family obligations, which means they can't be home to let their dog out to relieve themselves. Apartment or city living, means sidewalks and very little grass, some individuals may be incapable to walk a dog, but would love to have a dog.

Being one of those couples, who desired a dog, but our busy work life hindered that desire, and like so many others, there was no alternative, get home on time to let the dog out or face the consequences of urine and fecal piles in your house.

That is why we are introducing something new, and we were going to litter box train our dog. We decided to use an all-natural pine pellet litter, made with natural pine sawdust/pine sawdust particles, formed into pellets, with its natural color, biodegradable, odor absorbing, no additives, chemicals or perfumes. These resilient all-natural pine pellets do not breakdown during handling and storage.

When we brought home our 6 week old Great Dane puppy, we purchased a 3′ round poly plastic pool as our litter box, it was small enough for him to step into to relieve himself. We added about a 2″ depth of pine pellets around the entire bottom of the litter box. Like every puppy, repetition and stating “go potty outside” and taking him to the pine pellet litter box made it so easy for us to pine pellet litter train him. Since the pine pellets are all natural, with no additives, chemicals or perfumes, he did not hesitate to step into the litter box and relieve himself. Once the urine saturated the pine pellets they will swell up and over time the pine pellets will breakdown back into their natural state of pine sawdust/pine sawdust particles. There is no lingering urine odor, because the pine pellets absorbed the urine and destroyed the odor. When the dog would defecate, this would stay on top on the pellets and we would just pick up, with our hand in a bag and discard, just as you would do if he was to relieve himself outside. As our Great Dane dog grew larger, at about six (6) months of age, we accommodated our Great Dane dog with a larger 5′ round poly plastic pool. We added more pine pellets to accommodate his larger size, about a 4″ depth of pine pellets. For nearly a year now, when our Great Dane dog has to go relieve himself, he just goes to the pine pellet litter box.

When we took our Great Dane dog outside, he would relieve himself just like every other dog, but in the house, he would just go to the pine pellet litter box. We have left the dog alone for many hours, and even overnight and we are still amazed by the results, not one time has the dog had an accident in the house. Our Great Dane actually prefers to use the pine pellet litter box verse outdoors. No more anxiety for dogs that have to stand by the door waiting for his owner to let them out, no waking up in the middle of the night to let them out, no accidents in the house when you can't get home in time to let the dog out. Introducing the pine pellet litter box to a housebroken dog may take longer to train.

It is super easy to clean the litter box, depends on the size of the dog, with our large Great Dane, we removed and discarded the urine pine pellets that had turned to sawdust/sawdust particles with a small hand shovel. We did this about twice a week or so, leaving the unsoiled pellets in the litter box. When we removed the feces that lay on top of the pine pellets, we did so by using a plastic bag to pick it up then tied it closed and we discarded ours into a diaper pail. Any type of sealed container to discard waste is recommended. Optionally, you can add more pine pellets to replenish the supply. The entire litter box pine pellets were discarded about every two weeks, we washed down our litter box, smaller boxes can be wiped out, and replaced with fresh all-natural pine pellets. Smaller dogs would require less frequent cleanings.

There are many types of animal litters available for cats, birds, gerbils, hamsters, mice, rabbits, caged animals and so forth. Until now, dogs finally have an all-natural pine pellet litter that has been tested and proven to eliminate waste odors indoors. This all-natural pine pellet was deemed an excellent dog litter for all stages of life and sizes of dogs.

Yet, other types of litter exist and the most popular types of litter are clay, sand and other minimally sorbent materials. They also include additives for clumping, perfumes to mask waste odor and different types of chemical agents. Because dogs have a keen sense of smell, this type of litter maybe unacceptable to dogs and it does not control waste odors effectively. Many cats use these types of litters, when the cat urinates the odor is not absorbed. Unlike the all-natural pine pellets, it absorbs and destroys the odor on contact.

U.S. patent Ser. No. 15/226,028 discloses a method for removal of waste using a finely ground pine wood powder which includes a lubricant; cohesiveness agent; a mold inhibitor and fragrance. This patent is directed for cats as a clumping litter.

U.S. patent Ser. No. 14/079,669 discloses another method for removal of waste comprising of milled paper material and wood milled material. In addition, this patent discloses adding odor control agents; colorant agent; fixing agent and additives for moisture retention. This litter requires two types of milled products for creation along with several chemical agents.

U.S. patent Ser. No. 13/444,384 provides a composition useful as animal litter using cedar and/or pine along with a second component of corncob grain. This patent relates generally to the composition of said, suitable for use as a clumping animal litter.

U.S. patent Ser. No. 09/721,272 discloses yet another animal litter composition and methods for use using aspen wood particles and ground grain. Again, with clumping characteristics and may contain additives for sorbency, deodorants, anti-dusting and microbial growth agents.

### SUMMARY OF THE INVENTION

The present invention provides a method for the use of an all-natural pine pellet made from natural wood pine sawdust/pine sawdust particles, compressed and formed to make a pellet for the specific use in an indoor canine (dog) litter box.

It is further an object of the invention to provide a method for removal of dog waste using the pine pellet litter for urine and/or feces of dogs of all ages and stages of life.

Being all-natural, there are no chemicals, additives or perfumes. This pine pellet litter is highly absorbent, naturally odor controlling and is biodegradable.

### DETAILED DESCRIPTION OF THE INVENTION

The present invention provides a proven and tested method and use of an all-natural pine pellet litter to be used in an indoor canine (dog) litter box for waste removal.

All-natural pine sawdust/pine sawdust particles will have been compressed and formed into pellets. The pine sawdust/pine sawdust particles is of pine wood, for example, pine trees, timber or shavings. The pine sawdust/pine sawdust particles can be produced by any natural means, for example, cutting or grinding of said pine wood. The odor from the natural pine is extremely important since dogs have such a keen sense of smell. If perfumes were added, it is likely the dog would not use the litter box.

The pine pellet drying process can be done by either kiln drying from a pine lumber mill or it can be dried by a rotary dryer. The pine product is dried from 30-50% initial moisture down to 9-12% moisture prior to pelleting. There will also be a reduction in the volume of waste material generated.

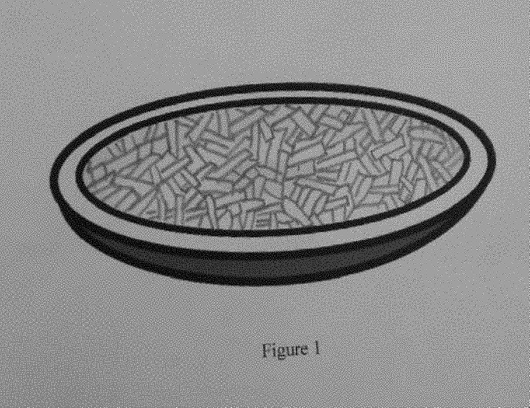

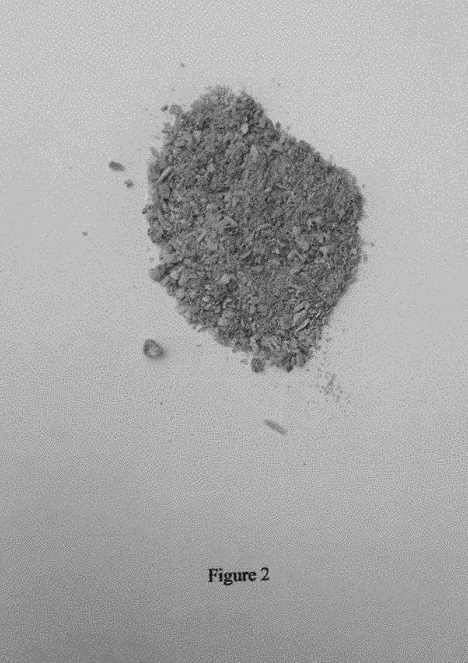

Pine pellet product is 100% biodegradable, so the used product can be composted with no harmful effects to the environment. Solid waste can be disposed of by bagging, flushing or used in flower beds. (not for use in vegetable gardens for human consumption) The method and use for the pine pellets are to be spread around the entire bottom of a litter box (FIG. 1 drawing) approximately 2″ to 4″ in depth depending on the size of said litter box. Upon use by the dog, once the urine saturates the pine pellets they will swell up and over time the pine pellets will breakdown back into their natural state of pine sawdust/pine sawdust particles (FIG. 2 drawing). There is no lingering urine odor, because the pine pellets absorbed the urine and destroys the odor. When the dog defecates on the pellets, the pellets remain solid and the feces stays on top of the pellets for easy removal.

It will be apparent to those skilled in the art that various changes can be made without departing from the scope of the invention. The invention is not to be considered limited to the container that is shown in the Figures and described in the specification.

The invention claimed is:

1. A method targeted for waste removal using an all-natural pine pellet to be used in an indoor canine litter box.

2. A method of claim 1 wherein it is highly absorbent, odor controlling, biodegradable, and

3. The method of claim 1 wherein it is an all-natural pine pellet made from natural pine sawdust/pine sawdust particles, compressed into a formed pellet, and

4. The method of claim 1, canine (dog) specific, urinates on said all-natural pine pellet, the pine pellet swells over time, pine pellet breaks down back into its original form of all-natural pine sawdust/pine sawdust particles, and

5. The method of claim 1, canine (dog) specific, defecates on said all-natural pine pellet, the pine pellet remains solid so waste stays on top for easy removal of solid waste.
